(19) United States
(12) Patent Application Publication
(10) Pub. No.: US 2011/0244294 A1
(43) Pub. Date: Oct. 6, 2011

(54) SECONDARY BATTERY THERMAL MANAGEMENT DEVICE AND SYSTEM

(75) Inventors: Taeyoung Han, Bloomfield Hills, MI (US); Kuo-Huey Chen, Troy, MI (US); Bahram Khalighi, Troy, MI (US); Steven G. Goebel, Victor, NY (US)

(73) Assignee: GM GLOBAL TECHNOLOGY OPERATIONS, INC., Detroit, MI (US)

(21) Appl. No.: 12/754,126

(22) Filed: Apr. 5, 2010

(51) Int. Cl. H01M 10/50

(52) U.S. Cl. 429/120

(57) ABSTRACT

A thermal management device for dissipating thermal energy from a secondary battery cell includes a first plate defining a first channel and a second channel spaced apart from the first channel, wherein the first plate further defines an inlet port in communication with the first channel and an outlet port in communication with the second channel and spaced opposite the inlet port. The device includes a second plate configured for thermal energy exchange with the cell and disposed in contact with the first plate to define a cross-flow channel, wherein the cross-flow channel interconnects the first and second channels. A thermal management system includes a cell having a first temperature, a fluid having a second temperature that is less than the first temperature, and the device. The fluid is conveyable from the inlet port to the outlet port via the cross-flow channel to thereby dissipate thermal energy from the cell.

### TECHNICAL FIELD

The present invention generally relates to thermal management devices and systems for dissipating thermal energy from a secondary battery cell.

### BACKGROUND OF THE INVENTION

Batteries are useful for converting chemical energy into electrical energy, and may be described as primary or secondary. Primary batteries are generally non-rechargeable, whereas secondary batteries are readily rechargeable and may be restored to a full charge after use. As such, secondary batteries may be useful for applications such as powering electronic devices, tools, machinery, and vehicles. For example, secondary batteries for vehicle applications may be recharged external to the vehicle via a plug-in electrical outlet, or onboard the vehicle via a regenerative event.

A secondary battery, which may also be known as a secondary battery pack, may include one or more secondary battery modules. Similarly, a secondary battery module may include one or more secondary battery cells positioned adjacent to each other, e.g., stacked.

When such secondary batteries are charged or discharged, heat is produced. If uncontrolled, such heat can detrimentally impact the life and performance of the secondary battery and/or individual secondary battery cells. Therefore, maintaining an even temperature distribution within the secondary batteries and secondary battery cells in order to operate the secondary battery within a desired operating temperature range is essential to maximizing the performance and longevity of the secondary battery.

### SUMMARY OF THE INVENTION

A thermal management device for dissipating thermal energy from a secondary battery cell includes a first plate defining a first channel and a second channel spaced apart from the first channel, wherein the first plate further defines an inlet port in communication with the first channel and an outlet port in communication with the second channel and spaced opposite the inlet port. Additionally, the thermal management device includes a second plate configured for thermal energy exchange with the secondary battery cell and disposed in contact with the first plate to define a cross-flow channel, wherein the cross-flow channel interconnects the first channel and the second channel.

In another variation, the first plate includes a first land, a second land, and a third land and defines the inlet port having a measurable inlet temperature during operation of the secondary battery cell and the outlet port having a measurable outlet temperature during operation of the secondary battery cell. The first land and the second land together define the first channel in communication with the inlet port. The second land and the third land together define the second channel in communication with the outlet port. Further, the second plate is adapted for supporting the secondary battery cell and has a first recess and a second recess that together define the cross-flow channel. Additionally, the first recess and the second recess is each disposed in contact with each of the first land, the second land, and the third land to thereby interconnect the cross-flow channel with each of the first channel and the second channel.

A thermal management system for dissipating thermal energy from a secondary battery during operation of the secondary battery includes a secondary battery cell having a measurable first temperature during operation, a fluid having a measurable second temperature during operation that is less than the measurable first temperature, and the thermal management device. The fluid is conveyable from the inlet port to the outlet port via the cross-flow channel to thereby dissipate thermal energy from the secondary battery cell.

The thermal management device and system provide excellent temperature control for secondary batteries. That is, the thermal management device and system provides uniform heat transfer between the thermal management device and the secondary battery cell, and therefore allow for excellent secondary battery temperature control during operation. In particular, the cross-flow channel allows for thermal conduction within the second plate to provide a uniform secondary battery cell temperature even as the measurable second temperature of the fluid increases from the inlet port to the outlet port. Further, the thermal management device and system allow for air cooling of secondary batteries. The cross-flow channel also allows for comparatively larger inlet and outlet ports to minimize pressure drop of the fluid across the secondary battery cell and/or secondary battery.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is an exploded schematic perspective view of a secondary battery and components thereof, including a plurality of secondary battery cells and a plurality of secondary battery modules;

FIG. 2 is an exploded schematic perspective view of a thermal management device for dissipating thermal energy from the secondary battery cell of the secondary battery of FIG. 1;

FIG. 3 is a schematic magnified perspective view of another variation of the thermal management device of FIG. 2;

FIG. 4 is a schematic magnified perspective view of yet another variation of the thermal management device of FIG. 2; and

FIG. 5 is an exploded schematic perspective view of a thermal management system including the secondary battery cell of FIG. 1, a fluid, and the thermal management device of FIG. 2.

### DESCRIPTION OF THE PREFERRED EMBODIMENTS

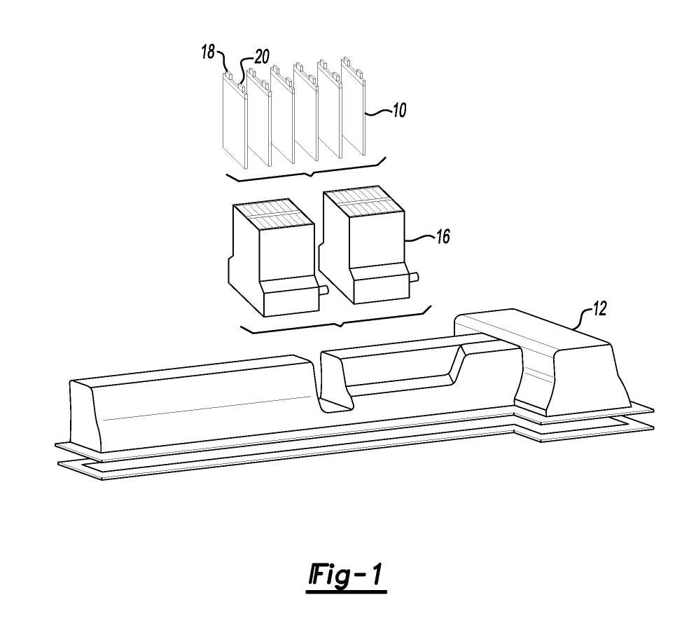

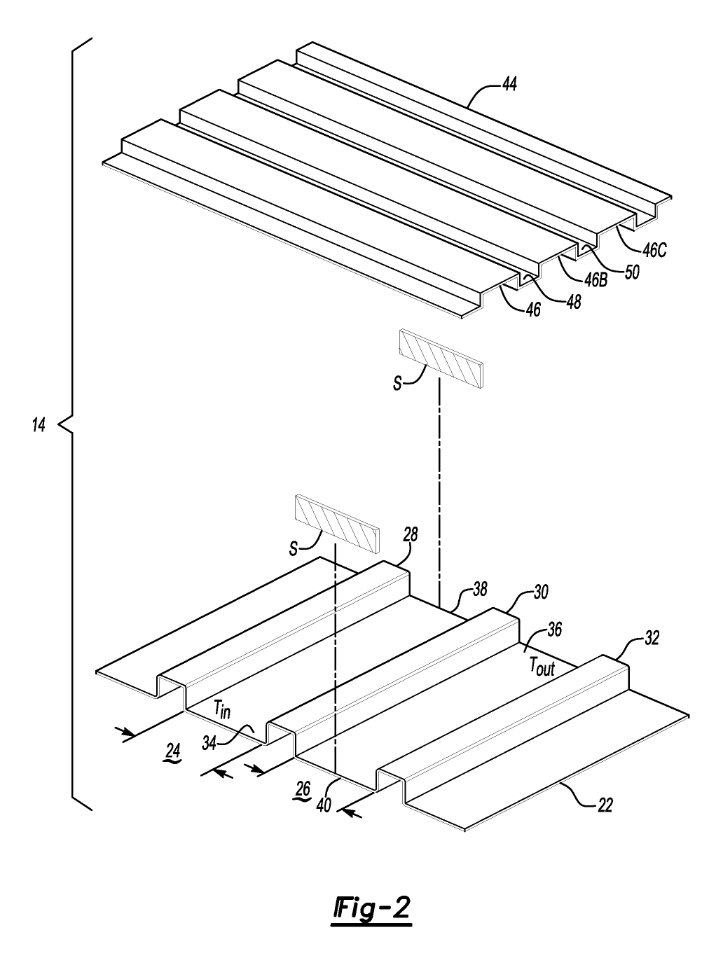

Referring to the Figures, wherein like reference numerals refer to like elements, a thermal management device for dissipating thermal energy from a secondary battery cell 10 (FIG. 1) of a secondary battery 12 (FIG. 1) is shown generally at 14 in FIG. 2. That is, the thermal management device 14 is configured for cooling the secondary battery cell 10 during operation. Therefore, the thermal management device 14 may be useful for a variety of applications requiring secondary battery cells 10, such as, but not limited to, electronic devices, tools, machinery, and vehicles. For example, the thermal management device 14 may be useful for lithium ion secondary batteries cells 10 for electric and hybrid electric vehicles. However, it is to be appreciated that the thermal management device 14 may also be useful for non-automotive applications, such as, but not limited to, household and industrial power tools and electronic devices.

Referring to FIG. 1, by way of general explanation, a secondary battery module for an automotive application is shown generally at 16. The secondary battery module 16 may be useful for automotive applications, such as for a plug-in hybrid electric vehicle (PHEV). For example, the secondary battery module 16 may be a lithium ion secondary battery module 16. Referring to FIG. 1, a plurality of battery modules 16 may be combined to form the secondary battery 12, i.e., the secondary battery pack. By way of example, the secondary battery module 16 may be sufficiently sized to provide a necessary voltage for powering a hybrid electric vehicle (HEV), an electric vehicle (EV), a plug-in hybrid electric vehicle (PHEV), and the like, e.g., approximately 300 to 400 volts or more, depending on the required application.

Referring again to FIG. 1, the secondary battery module 16 includes a plurality of secondary battery cells 10 positioned adjacent to and spaced from one another. The secondary battery cells 10 may be any suitable electrochemical battery cell. For example, the secondary battery cells 10 may be lithium ion, lithium ion polymer, lithium iron phosphate, lithium vanadium pentoxide, lithium copper chloride, lithium manganese dioxide, lithium sulfur, lithium titanate, nickel metal hydride, nickel cadmium, nickel hydrogen, nickel iron, sodium sulfur, vanadium redox, lead acid, and combinations thereof.

Referring again to FIG. 1, each secondary battery cell 10 may have a positive cell tab 18 and a negative cell tab 20. The secondary battery cell 10 may be suitable for stacking. That is, the secondary battery cell 10 may be formed from a heat-sealable, flexible foil that is sealed to enclose a cathode, an anode, and a separator (not shown) between the secondary battery cells 10. Therefore, any number of secondary battery cells 10 may be stacked or otherwise placed adjacent to each other to form a cell stack, i.e., the secondary battery module 16. Further, although not shown in FIG. 1, additional layers, such as, but not limited to, frames and/or cooling layers may also be positioned in the space between individual secondary battery cells 10. The actual number of secondary battery cells 10 may be expected to vary with the required voltage output of each secondary battery module 16. Likewise, the number of interconnected secondary battery modules 16 may vary to produce the necessary total output voltage for a specific application.

During operation, a chemical redox reaction may transfer electrons from a region of relatively negative potential to a region of relatively positive potential to thereby cycle, i.e., charge and discharge, the secondary battery cell 10 and the secondary battery 12 to provide voltage to power applications.

Referring now to FIG. 2, the thermal management device 14 includes a first plate 22. The first plate 22 may be formed from any suitable material, e.g., metal. The first plate 22 defines a first channel 24 and a second channel 26 spaced apart from the first channel 24. That is, the first channel 24 may be disposed substantially parallel to the second channel 26.

In one example, the first plate 22 may be stamped to form the first channel 24 and the second channel 26. That is, referring to FIG. 2, the first plate 22 may be stamped to include a first land 28, a second land 30, and a third land 32. The first land 28 and the second land 30 together define the first channel 24, and the second land 30 and the third land 32 together define the second channel 26 spaced apart from the first channel 24.

Referring again to FIG. 2, the first plate 22 further defines an inlet port 34 in communication with the first channel 24 and an outlet port 36 in communication with the second channel 26 and spaced opposite the inlet port 34. That is, the inlet port 34 of the first channel 24 is spaced laterally apart from and opposite the outlet port 36 of the second channel 26 by the second land 30. Therefore, a distal end 38 of the first channel 24 directly opposite the inlet port 34 may be blocked, e.g., closed off by a surface S or filling. Likewise, a proximal end 40 of the second channel 26 directly opposite the outlet port 36 may also be blocked by a like surface S, as shown in FIG. 2. The inlet port 34 has a measurable inlet temperature, Tᵢₙ, during operation and the outlet port 36 has a measurable outlet temperature, Tₒᵤₜ, during operation.

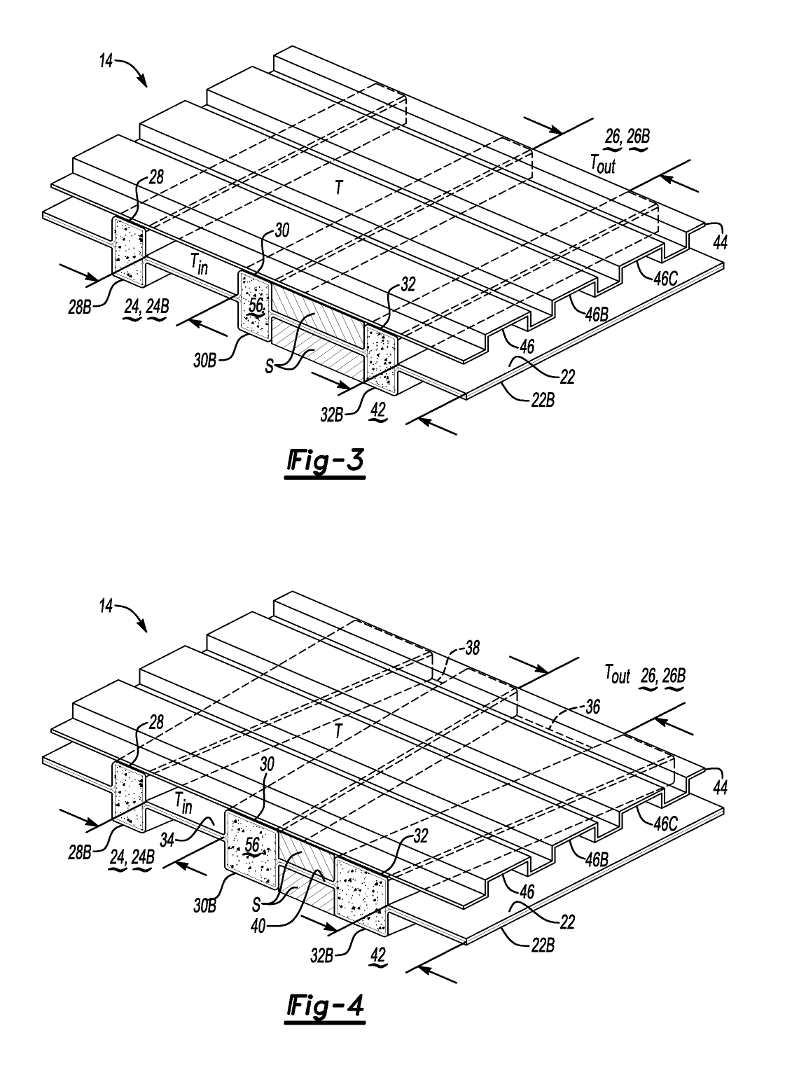

Referring to FIG. 3, the first plate 22 of the thermal management device 14 may also define at least one additional channel 42 spaced apart from at least one of the first channel 24 and the second channel 26. That is, the first plate 22 may define a plurality of first channels 24 and/or second channels 26. For variations including multiple first channels 24, 42 and/or second channels 26, the first channel 24 and the second channel 26 alternate laterally along the first plate 22. For example, as shown in FIG. 2, the second channel 26 may be disposed between two first channels 24, 42. Likewise, although not shown, the first channel 24 may be disposed between two second channels 26.

Referring to FIG. 4, in one variation, at least one of the first channel 24 and the second channel 26 may be tapered between the inlet port 34 and the outlet port 36. For example, the first channel 24 may converge, i.e., decrease in width, from the inlet port 34 to the proximal end 38 of the first channel 24. Additionally or alternatively, the second channel 26 may diverge, i.e., increase in width, from the proximal end 40 of the second channel 26 to the outlet port 36. Conversely, although not shown in FIG. 4, the first channel 24 may diverge from the inlet port 34 to the proximal end 38 of the first channel 24. Additionally or alternatively, the second channel 26 may converge from the proximal end 40 of the second channel 26 to the outlet port 36. In one non-limiting variation, the first channel 24 converges from the inlet port 34 to the proximal end 38 of the first channel 24, and the second channel 26 diverges from the proximal end 40 of the second channel 26 to the outlet port 36. In this variation, the first channel 24 and the second channel 26 together provide substantially uniform flow distribution through each of the cross-flow channels 46, 46B, 46C.

A shape of the tapered first channel 24 and/or second channel 26 may be defined by, for example, a linear straight profile, a non-linear quadratic profile, and/or a higher order profile (i.e., order n>4). Suitable shapes of the first channel 24 and/or second channel 26 achieve a uniform flow distribution across each cross-flow channel 46, 46B, 46C and may be obtained and selected from flow simulations using standard flow simulation software.

Referring again to FIG. 2, the thermal management device 14 also includes a second plate 44 configured for thermal energy exchange with the secondary battery cell 10 and disposed in contact with the first plate 22. The second plate 44 may also be formed from any suitable material, e.g., metal, and may be bonded, e.g., brazed, to the first plate 22. The second plate 44 defines a cross-flow channel 46. Referring to FIGS. 3-5, the cross-flow channel 46 may be disposed substantially perpendicular to each of the first channel 24 and the second channel 26 of the first plate 22 to thereby interconnect the first channel 24 and the second channel 26, as set forth in more detail below.

In one example, the second plate 44 may be stamped to form the cross-flow channel 46. That is, referring to FIG. 2, the second plate 44 may be stamped and have a first recess 48 and a second recess 50 that together define the cross-flow channel 46 so that the second plate 44 is adapted for supporting the secondary battery cell 10.

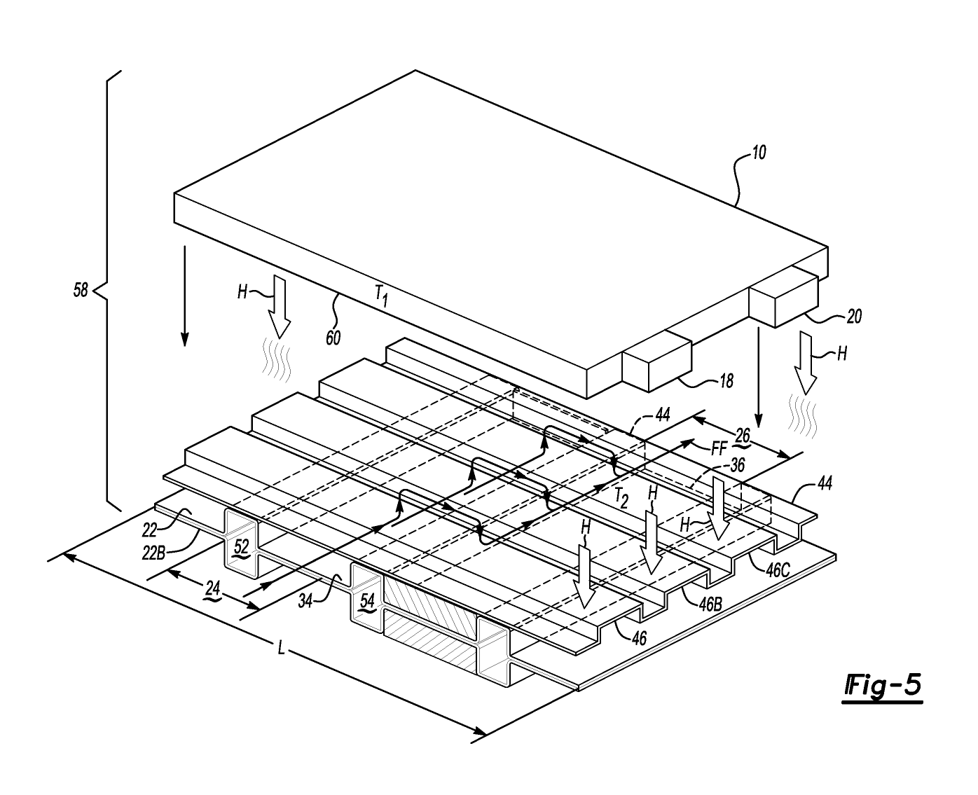

Referring to FIGS. 2-5, the cross-flow channel 46 interconnects the first channel 24 and the second channel 26. That is, the cross-flow channel 46 may be configured at least partially by the first plate 22 and the second plate 44 to provide a continuous path (designated by fluid flow arrows FF in FIG. 5) between the inlet port 34 of the first channel 24 and the outlet port 36 of the second channel 26. That is, in one variation, the first recess 48 (FIG. 2) and the second recess 50 (FIG. 2) is each disposed in contact with each of the first land 28, the second land 30, and the third land 32 to thereby interconnect the cross-flow channel 46 with each of the first channel 24 and the second channel 26.

As shown in FIGS. 2-5, the second plate 44 may define a plurality of cross-flow channels 46, 46B, 46C. Moreover, the plurality of cross-flow channels 46, 46B, 46C may each be disposed substantially perpendicular to each of the first channel 24, the second channel 26, and the at least one additional channel 42. That is, for variations including multiple first channels 24, 42, second channels 26, and/or cross-flow channels 46, 46B, 46C, each cross-flow channel 46, 46B, 46C may be disposed substantially perpendicular to each first channel 24 and each second channel 26 to thereby form a grid of interconnecting channels.

Referring now to FIG. 3, in one variation, the thermal management device 14 further includes an additional first plate 22B. The first plate 22 and the additional first plate 22B may be substantially identical and may be bonded, e.g., brazed, to each other. That is, referring to FIG. 3, the additional first plate 22B may also be stamped to include a first land 28B, a second land 30B, and a third land 32B. Additionally, as shown in FIG. 3, the first plate 22 and the additional first plate 22B may be inverted with respect to each other. In particular, with reference to FIGS. 3 and 5, the first channels 24, 24B of the respective first plate 22 and additional first plate 22B may be bonded to one another to define a first cavity 52 (FIG. 5) between each of the first lands 28, 28B of the first plates 22, 22B. Likewise, the second channels 26, 26B of the respective first plate 22 and additional first plate 22B may be bonded to one another to define a second cavity 54 (FIG. 5) between each of the second lands 30, 30B of the first plates 22, 22B.

In this variation, referring to FIG. 3, the thermal management device 14 may include a phase change material 56 disposed within at least one of the first cavity 52 and the second cavity 54. That is, the phase change material 56 may be disposed within one or both of the first cavity 52 and the second cavity 54.

As used herein, the terminology “phase change material” refers to a material that absorbs and releases heat when the material changes between a solid phase and a liquid phase at a melting temperature, Tₘ. Therefore, the phase change material 56 may also be referred to as a latent heat storage material. The phase change material 56 is changeable between the solid phase and the liquid phase in response to a temperature, T, equal from about the measurable inlet temperature, Tᵢₙ, to about the measurable outlet temperature, Tₒᵤₜ. That is, during operation, when the temperature, T, within the interconnected first channel 24, second channel 26, and cross-flow channel 46, 46B, 46C reaches the melting temperature, Tₘ, of the phase change material 56, the phase change material 56 absorbs a significant amount of heat without a corresponding increase in temperature of the phase change material 56 until the phase change material 56 changes from the solid phase to the liquid phase. Conversely, during operation, as the temperature, T, within the interconnected first channel 24, second channel 26, and cross-flow channel 46 falls below the melting temperature, Tₘ, of the phase change material 56, the phase change material 56 solidifies and releases stored latent heat.

Suitable phase change materials 56 may include, but are not limited to, organic phase change materials, inorganic phase change materials, and eutectic phase change materials including a combination of organic-organic, organic-inorganic, and/or inorganic-inorganic materials.

Referring now to FIG. 5, a thermal management system for dissipating thermal energy from the secondary battery 12 (FIG. 1) during operation of the secondary battery 12 is shown generally at 58. The thermal management system 58 includes the secondary battery cell 10 having a measurable first temperature, T₁ during operation. The measurable first temperature, T₁, of the secondary battery cell 10 may be equal to from about 25° C. to about 40° C., e.g., from about 25° C. to about 35° C.

The thermal management system 58 also includes a fluid (represented by arrows FF in FIG. 5) having a measurable second temperature, T₂, during operation that is less than the measurable first temperature, T₁. The fluid (arrows FF) may be a gas, such as air, a liquid, such as a hydrocarbon refrigerant, or combinations thereof, such as a carbonated liquid. Further, the fluid (arrows FF) may be passively or actively circulated into the first channel 24. For example, the fluid (arrows FF) may drift into the first channel 24 or may be blown into the first channel 24 by a fan. Air is a suitable fluid (arrows FF) of the thermal management system 58.

Referring to FIG. 5, the fluid (arrows FF) is conveyable from the inlet port 34 to the outlet port 36 via the cross-flow channel 46, 46B, 46C to thereby dissipate thermal energy (represented by arrows H) from the secondary battery cell 10. That is, the cross-flow channel 46 may convey the fluid (arrows FF) from the first channel 24 to the second channel 26 and form the aforementioned continuous path between the inlet port 34 and the outlet port 36. Stated differently, the cross-flow channel 46, 46B, 46C allows the fluid (arrows FF) to pass in a path generally indicated by fluid flow arrows FF. In particular, the cross-flow channel 46 allows the fluid (arrows FF) to pass from the inlet port 34 through the first channel 24, across the second land 30 to the second channel 26, and from the second channel 26 to the outlet port 36.

Referring to FIG. 5, the second plate 44 is configured for thermal energy exchange with the secondary battery cell 10. For example, the second plate 44 may be disposed in thermal energy exchange relationship with each of the fluid (arrows FF) and the secondary battery cell 10. In particular, the second plate 44 may be disposed between each of the secondary battery cell 10 and the fluid (arrows FF). That is, a substantially flat face 60 of the secondary battery cell 10 may interface in thermal energy exchange relationship with the thermal management device 14 (FIG. 2) as the secondary battery cell 10 extends along a length, L, of the thermal management device 14. That is, the second plate 44 may be disposed adjacent and/or in contact with the secondary battery cell 10 so that thermal energy (arrows H), i.e., heat, from the secondary battery cell 10 may be transferred to the second plate 44, and from the second plate 44 to the fluid (arrows FF). Therefore, as the fluid (arrows FF) flows from the first channel 24 to the second channel 26 by way of the cross-flow channel 46, 46B, 46C, the fluid (arrows FF) may dissipate thermal energy (arrows H) from the secondary battery cell 10 and thereby cool the secondary battery cell 10. It is to be appreciated that the inlet port 34 and the outlet port 36 can each be optimally sized to allow for a desired amount of fluid (arrows FF) at a desired pressure to pass through the first channel 24 to the second channel 26 by way of the cross-flow channel 46, to both optimize transfer of thermal energy (arrows H) and minimize pressure drop of the fluid (arrows FF). And, at least one thermal management device 14 may abut each secondary battery cell 10 of the secondary battery module 18 (FIG. 1). That is, one thermal management device 14 may be sandwiched between two adjacent secondary battery cells 10 of the secondary battery module 18 (FIG. 1).

Consequently, during operation of the secondary battery 12, a difference, ΔT, between the measurable inlet temperature, Tᵢₙ, and the measurable outlet temperature, Tₒᵤₜ, may be less than or equal to about 10° C., while the measurable first temperature, T₁, within the secondary battery cell 10 may vary by less than or equal to about 2° C. during operation. That is, during operation, the measurable first temperature, T₁, within the secondary battery cell 10 may not vary by more than about 2° C. so that the secondary battery 12 (FIG. 1) including multiple secondary battery cells 10 may operate within a temperature range of from about 25° C. to about 40° C. Therefore, the cross-flow channel 46 provides excellent cooling of the secondary battery cells 10, minimizes uneven temperature distribution, and thereby provides a substantially uniform temperature distribution across the secondary battery cell 10.

The thermal management device 14 and the thermal management system 58 including the thermal management device 14 provide excellent temperature control for secondary batteries 12. That is, the thermal management device 14 and system 58 provides uniform heat transfer between the thermal management device 14 and the secondary battery cell 10, and therefore allow for excellent secondary battery temperature control during operation. In particular, the cross-flow channel 46 allows for thermal conduction within the second plate 44 to provide a uniform secondary battery cell temperature, T, even as the measurable second temperature, T₂, of the fluid (arrows FF) increases from the inlet port 34 to the outlet port 36. Further, the thermal management device 14 and system 58 allow for air cooling of secondary batteries 12. The cross-flow channel 46 also allows for comparatively larger inlet and outlet ports 34, 36 to minimize pressure drop of the fluid (arrows FF) across the secondary battery cell 10 and/or secondary battery 12.

While the best modes for carrying out the invention have been described in detail, those familiar with the art to which this invention relates will recognize various alternative designs and embodiments for practicing the invention within the scope of the appended claims.

1. A thermal management device for dissipating thermal energy from a secondary battery cell, the thermal management device comprising:
a first plate defining a first channel and a second channel spaced apart from said first channel, wherein said first plate further defines an inlet port in communication with said first channel and an outlet port in communication with said second channel and spaced opposite said inlet port; and
a second plate configured for thermal energy exchange with the secondary battery cell and disposed in contact with said first plate to define a cross-flow channel, wherein said cross-flow channel interconnects said first channel and said second channel.

2. The thermal management device of claim 1, wherein said cross-flow channel is configured at least partially by said first plate and said second plate to provide a continuous path between said inlet port and said outlet port.

3. The thermal management device of claim 1, wherein said cross-flow channel is disposed substantially perpendicular to each of said first channel and said second channel.

4. The thermal management device of claim 1, wherein said second plate is bonded to said first plate.

5. The thermal management device of claim 1, wherein at least one of said first channel and said second channel is tapered between said inlet port and said outlet port.

6. A thermal management device for dissipating thermal energy from a secondary battery cell, the thermal management device comprising:
a first plate including a first land, a second land, and a third land and defining an inlet port having a measurable inlet temperature during operation of the secondary battery cell and an outlet port spaced opposite said inlet port and having a measurable outlet temperature during operation of the secondary battery cell, wherein said first land and said second land together define a first channel in communication with said inlet port, and wherein said second land and said third land together define a second channel in communication with said outlet port and spaced apart from said first channel; and
a second plate adapted for supporting the secondary battery cell and having a first recess and a second recess together defining a cross-flow channel, wherein said first recess and said second recess is each disposed in contact with each of said first land, said second land, and said third land to thereby interconnect said cross-flow channel with each of said first channel and said second channel.

7. The thermal management device of claim 6, further including an additional first plate, wherein said first channels are bonded to one another to define a first cavity between said each of said first lands and said second channels are bonded to one another to define a second cavity between each of said second lands.

8. The thermal management device of claim 7, further including a phase change material disposed within at least one of said first cavity and said second cavity.

9. The thermal management device of claim 8, wherein said phase change material is changeable between a solid phase and a liquid phase in response to a temperature equal to from about said measurable inlet temperature to about said measurable outlet temperature.

10. A thermal management system for dissipating thermal energy from a secondary battery during operation of the secondary battery, the thermal management system comprising:
a secondary battery cell having a measurable first temperature during operation of the secondary battery;
a fluid having a measurable second temperature during operation of the secondary battery that is less than said measurable first temperature; and
a thermal management device including;
a first plate defining a first channel and a second channel spaced apart from said first channel, wherein said first plate further defines an inlet port in fluid flow communication with said first channel and having a measurable inlet temperature during operation of the secondary battery, and an outlet port in fluid flow communication with said second channel, spaced opposite said inlet port, and having a measurable outlet temperature during operation of the secondary battery; and
a second plate configured for thermal energy exchange with said secondary battery cell and disposed in contact with said first plate to define a cross-flow channel, wherein said cross-flow channel interconnects said first channel and said second channel;
wherein said fluid is conveyable from said inlet port to said outlet port via said cross-flow channel to thereby dissipate thermal energy from said secondary battery cell.

11. The thermal management system of claim 10, wherein a difference between said measurable inlet temperature and said measurable outlet temperature is less than or equal to about 10° C. during operation of the secondary battery.

12. The thermal management system of claim 10, wherein said second plate is disposed in thermal energy exchange relationship with each of said fluid and said secondary battery cell.

13. The thermal management system of claim 10, wherein said measurable first temperature is equal to from about 25° C. to about 40° C. during operation of the secondary battery.

14. The thermal management system of claim 10, wherein said cross-flow channel is disposed substantially perpendicular to each of said first channel and said second channel.

15. The thermal management system of claim 14, wherein said cross-flow channel conveys said fluid from said first channel to said second channel.

16. The thermal management system of claim 10, wherein said second plate defines a plurality of cross-flow channels.

17. The thermal management system of claim 10, wherein said first plate defines at least one additional channel spaced apart from at least one of said first channel and said second channel.

18. The thermal management system of claim 17, wherein said second plate defines a plurality of cross-flow channels each disposed substantially perpendicular to each of said first channel, said second channel, and said at least one additional channel.

19. The thermal management device of claim 10, further including an additional first plate, wherein said first channels are bonded to one another to define a first cavity between said each of said first plates and said second channels are bonded to one another to define a second cavity between each of said first plates.

20. The thermal management system of claim 19, further including a phase change material disposed between said first plates.
